(19) United States
(12) Patent Application Publication
(10) Pub. No.: US 2003/0061724 A1
(43) Pub. Date: Apr. 3, 2003

(54) Measuring device, measurement station, production line and measuring method for measuring the distance projected in a preferred direction between a measurement plane and a measurement area

(76) Inventors: Manfred Bodenmueller, Graben-Neudorf (DE); Lothar Mueller, Heidelberg (DE)

Correspondence Address: HARNESS, DICKEY & PIERCE, P.L.C., P.O.BOX 8910, RESTON, VA, 20195, US

(21) Appl. No.: 10/189,435

(22) Filed: Jul. 8, 2002

(30) Foreign Application Priority Data
Oct. 2, 2001 (DE) 10148628.6

(51) Int. Cl. G01B 3/22

(52) U.S. Cl. 33/832

(57) ABSTRACT

A measuring device and method for measuring the vertical difference between a measurement plane and a measurement area is disclosed. The device and method include a contact element, which contacts the measurement plane during a measurement procedure, a measuring element, which is mounted such that it can be displaced along the preferred direction relative to the contact element and which contacts the measurement area during the measurement procedure, a distance measuring system, which is constructed and arranged in such a way that a displacement of the measuring element relative to the contact element can be registered, and at least one compensating weight, which is firmly connected to the contact element and is arranged in the outer area of contact element and measuring element.

This application claims priority of German Patent Application No. 10148628.6, filed Oct. 2, 2001, the entire contents of which are hereby incorporated by reference.

### BACKGROUND OF THE INVENTION

1. Field of the Invention

The present invention relates a measuring device, a measurement station, a production line and a measuring method for measuring the distance projected in a preferred direction between a measurement plane of an object to be measured and a measurement area of an object to be measured, in particular for measuring the vertical difference between the measurement plane and the measurement area.

2. Related Art

Automated production or mounting of components, for example diesel injectors, frequently requires accurate physical measurement of the components. In particular, the measurement of the distance projected in a preferred direction between a measurement plane and a measurement area of the component plays an important part in the production or the mounting of precision components. Vertical difference measurements of this type within produced, mounted or previously mounted components are made considerably more difficult by inherent oscillations of the mounting station and/or by external oscillations which, for example, are caused by production or mounting processes proceeding in the vicinity. This difficulty is caused in particular by the fact that, because of mechanical vibration and/or oscillations, reliable and precise contact between the measuring elements required for the vertical difference measurement and the measurement plane and/or the measurement area are barely possible. In particular, precise vertical difference measurements, in which it is not the absolute position of the measurement area or the measurement plane which is determined but, within the context of a differential measurement, only the vertical difference between the measurement area and the measurement plane, are virtually impossible as a result of mechanical vibration and oscillations. For this reason, if the measurement is made more difficult by mechanical vibration or oscillations, the vertical difference measurement between measurement area and measurement plane is normally carried out by way of different measuring devices having different measuring head variants. In this case, by way of a first measuring device, first of all the vertical position of the measurement plane and then, by way of a second measuring device, the vertical position of the measurement area is determined. The differential measurement by way of separate measuring devices has the disadvantage that the measurement accuracy that can be achieved is reduced considerably as compared with a direct differential measurement.

### SUMMARY OF THE INVENTION

The present invention is therefore based, in part, on the object of providing a measuring device, a measurement station, a production line and a measuring method with which a precise direct vertical difference measurement between the measurement plane of an object to be measured and the measurement area of the object to be measured can be carried out even when the vertical difference measurement is made more difficult by mechanical vibration and/or oscillations.

According to the present invention, this object, and other objects of the present invention, is achieved by a measuring device having a contact element, which contacts the measurement plane during a measurement procedure, a measuring element, which is mounted such that it can be displaced relative to the contact element along the preferred direction and which contacts the measurement area during the measurement procedure, a distance measuring system, which is constructed and arranged in such a way that a displacement of the measuring element relative to the contact element can be registered, and at least one compensating weight, which is firmly connected to the contact element and is arranged in the outer area of contact element and measuring element.

According to a preferred embodiment of the present invention, the compensating weight is arranged and designed in such a way that the mass center of gravity of the measuring device is lower than the measurement plane and/or the measurement area. As a result, without the use of a complicated mechanical holder for the measuring device, it is ensured that the measuring device is always oriented in a defined physical position marked out by the force of gravity.

According to a further preferred embodiment of the present invention, the contact element has three contact supports, whose ends make contact with the measurement plane during a measurement procedure. Such three-point contact between the contact element and the measurement plane of the object to be measured has the advantage that the sensitivity of the measurement procedure to mechanical vibration and/or oscillations is additionally reduced.

According to an embodiment of the invention, the measuring device additionally has a guide element, by way of which precise mounting of the measuring element relative to the contact element is ensured.

The adjusting device has the advantage that, as a result of adapting the physical position of the guide element relative to the contact element, the measuring device can be matched in a simple way to the shape of the object to be measured.

The device-related object on which the invention is based is further achieved by a measurement station and by a production line.

The mounting for the measuring device has the advantage that the contact forces with which the contact element makes contact with the measurement plane and the measuring element makes contact with the measurement area depend only on the force of gravity, and therefore a constant contact force is ensured during the entire measurement procedure.

The method-related object on which the invention is based is achieved by a measuring method.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 illustrates a measurement station having a physically firmly arranged measuring head; and

FIG. 2 illustrates an enlarged illustration of the measuring head depicted in FIG. 1.

### DETAILED DESCRIPTION OF THE PREFERRED EMBODIMENTS

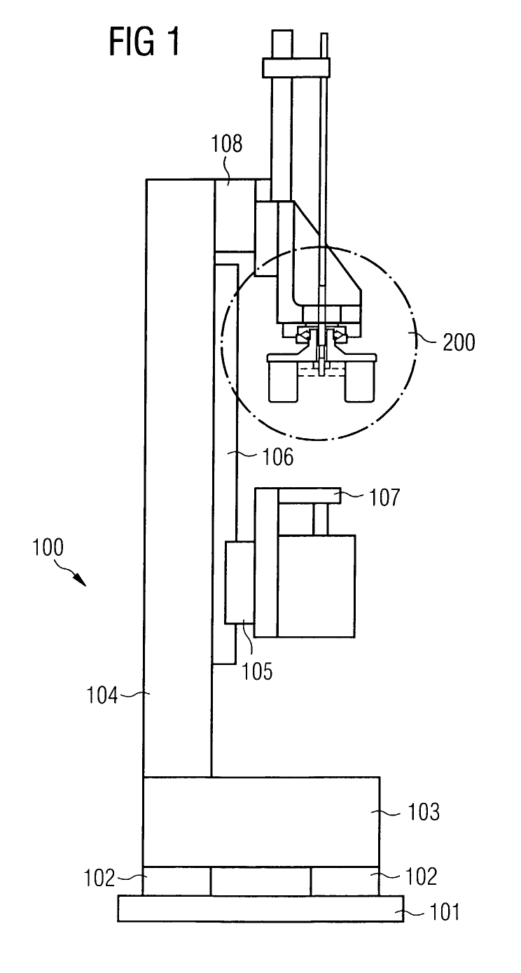

FIG. 1 illustrates a schematic illustration of a measurement station 100 according to an exemplary embodiment of the present invention. The measurement station 100 has a base element 101 which ensures a stable construction of the measurement station 100. The measurement station 100 further has a machine base plate 103, which is connected to the base plate 101 via two damping elements 102. The damping elements 102 have the task of damping mechanical oscillations, which are produced by production and/or mounting stations or the like located in the vicinity, as highly as possible. In the schematic illustration shown in FIG. 1, only two damping elements 102 are illustrated. It is pointed out that, for the best possible mechanical decoupling, that is to say for effective oscillation damping between the base element 101 and the machine base plate 103, a plurality of damping elements 102 can be used, which preferably in each case have high damping values for different oscillation frequencies, so that mechanical oscillations are damped as well as possible over a wide frequency range.

Fixed to the machine base plate 103 is a vertical structure 104, which carries the components of the measurement station 100 required for the vertical difference measurement. These components are in particular a measuring head 200 and a carrier 107 for the object to be measured.

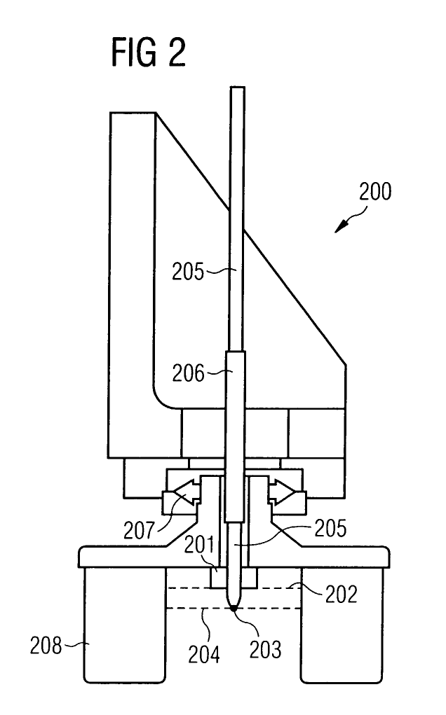

The measuring head 200, which will be explained in detail below using FIG. 2, is connected to the vertical structure 104 via a rigid boom 108, according to the exemplary embodiment described here. In this case, the measuring head 200 is suspended on the rigid boom in such a way that the measuring head 200 can be lifted by an object to be measured brought up from below. The carrier 107 for the object to be measured can be moved relative to the vertical structure 104, and therefore also relative to the measuring head 200 fitted to the rigid boom 108, by way of a vertical displacement device. In this way, an object to be measured, which is not illustrated in FIG. 1 but which is located on or at the carrier 107 for the object to be measured, can be brought up from below in the vertical direction to the measuring head 200. The vertical displacement device is illustrated in FIG. 1 by way of a vertical guide 106 fitted to the vertical structure 104 and also by a vertical carriage 105 rigidly connected to the carrier for the object to be measured.

At this point, it is pointed out that, of course, in addition to the vertical displacement device, one or preferably two horizontal displacement devices can be used, so that the object to be measured can be moved not only in the vertical but also in any desired horizontal direction relative to the measuring head 200. In this way, inaccuracies in the positioning of the object to be measured on or at the carrier 107 for the object to be measured can be corrected in a simple way.

In addition to the vertical and/or horizontal displacement devices, the measurement station 100 can also have a tilting device and/or a rotating device, by way of which the object to be measured and/or the measuring head 200 can be rotated or tilted relative to the preferred vertical direction.

All the displacement devices, the tilting device and/or the rotating device are preferably driven pneumatically. In this way, no vibrations or only very weak vibrations are generated by a movement of the carrier 107 for the object to be measured and/or of the measuring head 200, for example for the adjustment of the measurement station.

If the measurement station 100, in addition to the vertical displacement device, has one or more horizontal displacement devices and/or a tilting or rotating device, the rigid boom 108 illustrated in FIG. 1 can be replaced by a horizontal displacement device and/or a tilting or rotating device.

FIG. 2 illustrates an enlarged illustration of a cross-sectional view of the measuring head 200 depicted in FIG. 1. The measuring head 200 has a contact element 201 which, during a measurement procedure, contacts a measurement plane 202 of the object to be measured (not illustrated). According to the exemplary embodiment of the invention described here, the contact element 201 has three contact supports, of which only two can be seen in the cross-sectional view illustrated in FIG. 2. Each of the three contact supports preferably makes contact with the measurement area 202 with an approximately point-like contact area. The measuring head 200 further has a measuring element 205 which, according to the exemplary embodiment illustrated, is formed as a long, cylindrical rod. The measuring element 205 has at its lower end a measuring tip 203 which, during a measurement procedure, contacts a measurement area 204 on the object to be measured. As can be seen from FIG. 2, because of the shape and the relative arrangement between contact element 201 and measuring tip 203, a depression in the object to be measured (not illustrated) can be determined precisely. It is pointed out that, of course, in the case of a different shape and a different physical arrangement between contact element 201 and measuring tip 203, an elevation on the object to be measured can be registered. In this case, the contact element 201 would have to be formed in such a way that the contact supports contact the object to be measured outside the elevation to be registered.

In order to ensure defined mounting of the measuring element 205 relative to the contact element 201, the measuring element 205 is mounted in a stationary position at right angles to the preferred vertical direction and such that it can be displaced within a guide element 206 along the preferred vertical direction. The guide element 206 also has a distance measuring system, not specifically illustrated, by way of which longitudinal displacement of the measuring element 205 can be registered. The guide element 206 can be displaced by way of an adjusting device 207 at right angles to the preferred direction predefined by the longitudinal axis of the measuring element 205. According to the exemplary embodiment of the invention described here, precise displacement by the adjusting device 207 is achieved by way of three centering pins, of which only two centering pins are illustrated in FIG. 2 because of the cross-sectional view. The adjusting device 207 permits precise matching of the relative position between contact element 201 and measuring tip 203 and the object to be measured, so that the measuring head 200 can be used for a multiplicity of different objects to be measured.

The measuring head 200 also has at least one compensating weight 208, which is arranged and designed in such a way that the mass center of gravity of the measuring head 200 is lower than the measurement plane 202 and/or the measurement area 204. If the entire measuring head 200 is additionally mounted in such a way that it is easily lifted when the carrier 107 for the object to be measured is brought up from below by the object to be measured located on the carrier 107 for the object to be measured, a defined contact force of the contact element 201 on the measurement area 204 can be ensured in this way, since this contact force then depends only on the weight of the measuring head 200.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A measuring device for measuring a distance projected in a preferred direction between a measurement plane of an object to be measured and a measurement area of the object to be measured, the measuring device comprising:
a contact element, which contacts the measurement plane during a measurement procedure,
a measuring element, which is mounted such that it can be displaced relative to the contact element along the preferred direction and which contacts the measurement area during the measurement procedure,
a distance measuring system, which is constructed and arranged in such a way that a displacement of the measuring element relative to the contact element can be registered, and
at least one compensating weight, which is firmly connected to the contact element and is arranged in the outer area of contact element and measuring element.

2. The measuring device as claimed in claim 1, wherein the compensating weight is arranged and designed in such a way that the mass center of gravity of the measuring device is lower than the measurement plane.

3. The measuring device as claimed in claim 1, wherein the contact element has three contact supports, whose ends contact the measurement plane during a measurement procedure.

4. The measuring device as claimed in claim 1, further comprising a guide element, being arranged in a fixed position relative to the contact element, at least in the course of a measurement procedure, and which is formed in such a way that, relative to the contact element, the measuring element is in a fixed position at right angles to the preferred direction and is mounted such that it can be displaced along the preferred direction.

5. The measuring device as claimed in claim 4, further comprising an adjusting device for adjusting the physical position of the guide element relative to the contact element.

6. A measurement station for measuring the distance projected in a preferred direction between a measurement plane of an object to be measured and a measurement area of the object to be measured, the measurement station comprising:
a measuring device,
a carrier for an object to be measured, on which the object to be measured can be laid or to which the object to be measured can be fitted, and
a movement device, which is constructed in such a way that the measuring device can be moved relative to the carrier for the object to be measured.

7. The measurement station as claimed in claim 6, wherein the measuring device is a measuring device of claim 1.

8. The measurement station as claimed in claim 7, wherein the measuring device is mounted in such a way that it can be placed freely on the object to be measured, at least in the vertical direction, so that the contact force of the contact element on the measurement area depends substantially on the weight of the measuring device.

9. The measurement station as claimed in claim 6, wherein the movement device has a vertical displacement device, by way of which the measuring device can be displaced linearly in the vertical direction relative to the carrier for the object to be measured.

10. The measurement station as claimed in claim 6, wherein the movement device comprises at least one horizontal displacement device, by way of which the measuring device can be displaced linearly in the horizontal direction relative to the carrier for the object to be measured.

11. The measurement station as claimed in claim 6, further comprising at least one tilting device, by way of which the measuring device can be tilted relative to the preferred direction relative to the carrier for the object to be measured.

12. The measurement station as claimed in claim 6, further comprising a rotating device, by way of which the measuring device can be rotated parallel to the preferred direction relative to the carrier for the object to be measured.

13. The measurement station according to claim 6, additionally comprising a base element which is arranged in a fixed position relative to the measuring device.

14. The measurement station as claimed in claim 13, further comprising at least one damping element, being arranged between the base element and the measuring device or between the base element and the carrier for the object to be measured, the at least damping element constructed in such a way that mechanical oscillatory coupling between the base element and the measuring device or between the base element and the carrier for the object to be measured is at least attenuated.

15. A production line having a measurement station as claimed in claim 7.

16. A measuring method for measuring the distance projected in a preferred direction between a measurement plane of an object to be measured and a measurement area of the object to be measured, using a measuring device as claimed in claim 1 or using a measurement station as claimed in claim 6, in particular for measuring the vertical difference between the measurement plane and the measurement area, the method comprising:
positioning the object to be measured relative to the measuring device in such a way that the contact element contacts the measurement plane,
holding the guide element in a fixed physical position relative to the contact element,
registering the vertical difference between the measurement plane and the measurement area by using the displacement of the measuring element relative to the contact element.

17. The measuring method as claimed in claim 16, wherein before the contact element makes contact with the measurement plane, the physical position of the guide element relative to the contact element is adjusted by way of the adjusting device in such a way that during subsequent registration of the vertical difference the measuring element rests on the measurement area when the contact element contacts the measurement plane.

18. The measurement method as claimed in claim 16, wherein the positioning of the object to be measured relative to the measuring device is carried out in such a way that the object to be measured is moved up from below to the measuring device, so that the measuring device is lifted.

19. The measuring device as claimed in claim 1, wherein the measuring device measures a vertical difference between the measurement plane and the measurement area.

20. The measuring device as claimed in claim 1, wherein the compensating weight is arranged and designed in such a way that the mass center of gravity of the measuring device is lower than the measurement area.

21. The measurement station as claimed in claim 6, wherein the measurement station measures a vertical difference between the measurement plane and the measurement area.

22. The measurement station as claimed in claim 7, wherein the movement device has a vertical displacement device, by way of which the measuring device can be displaced linearly in the vertical direction relative to the carrier for the object to be measured.

23. The measurement station as claimed in claim 7, wherein the movement device comprises at least one horizontal displacement device, by way of which the measuring device can be displaced linearly in the horizontal direction relative to the carrier for the object to be measured.

24. The measurement station as claimed in claim 7, further comprising at least one tilting device, by way of which the measuring device can be tilted relative to the preferred direction relative to the carrier for the object to be measured.

25. The measurement station as claimed in claim 7, further comprising a rotating device, by way of which the measuring device can be rotated parallel to the preferred direction relative to the carrier for the object to be measured.

26. The measurement station according to claim 7, additionally comprising a base element which is arranged in a fixed position relative to the measuring device.
